(19) United States
(12) Patent Application Publication
(10) Pub. No.: US 2019/0389244 A1
(43) Pub. Date: Dec. 26, 2019

(54) WHEEL SPOKE BACK CAVITY WEIGHT REDUCTION SOCKET

(71) Applicant: CITIC Dicastal CO., LTD., Qinhuangdao (CN)

(72) Inventor: Jinyun Tian, Qinhuangdao (CN)

(21) Appl. No.: 16/260,292

(22) Filed: Jan. 29, 2019

(30) Foreign Application Priority Data
Jun. 26, 2018 (CN) 201810666438.1

(51) Int. Cl. B60B 3/00; B60B 3/04; B60B 3/12

(52) U.S. Cl. CPC B60B 3/007; B60B 3/12; B60B 3/004; B60B 3/04

(57) ABSTRACT

A motor vehicle aluminum alloy hub having weight reduction sockets at the back cavity includes a wheel disc and a rim; the wheel disc includes a flange, a flange peripheral portion and spokes; the spoke includes a spoke main arm on one side close to the flange, and two spoke branch arms extend from the spoke main arm; the spoke includes a spoke weight reduction socket on one side of the back cavity, and the spoke weight reduction socket is V-shaped; the spokes include five flange peripheral portion weight reduction sockets uniformly distributed around the flange on the back of the flange peripheral portion; and the flange includes flange weight reduction sockets between bolt holes on one side of the back cavity.

### CROSS-REFERENCE TO RELATED APPLICATIONS

The present application claims benefit of Chinese Application No. 201810666438.1, filed on Jun. 26, 2018, the contents of which are hereby incorporated by reference in its entirety.

### BACKGROUND

Aluminum alloy hubs have won the favor of more and more private car owners by attractive appearance, safety, comfort and other characteristics. Since the aluminum alloy hubs are light and high in manufacturing precision, the deformation is small during high-speed rotation, and the inertial resistance is also small. The aluminum alloy hubs have the metal characteristics of absorbing vibration and rebounding force, and have the advantages of high dimensional accuracy, high roundness, small yaw and good balance after being machined by numerical control machines, so that cars are driven smoothly and comfortably.

When an aluminum alloy hub of a motor vehicle is designed, the design result of a front wheel disc may be slightly different from the optimal weight result. When the front wheel disc covers a too large area, the overall wheel has an excessive wheel disc weight, which offsets the advantage of the aluminum alloy hub in weight reduction. In order to overcome this problem, weight reduction sockets are usually provided on the back of spokes of the wheel disc to reduce the overall weight of the wheel disc. However, the setting of the weight reduction sockets may affect the mechanical strength of the aluminum alloy hub, especially the impact strength and the fatigue performance, and even cause the aluminum alloy hub to fail in relevant tests.

Thus, it has been desirable in the art to balance the weight reduction and the mechanical strength by designing appropriate weight reduction sockets for the front side design of the specific wheel disc to reduce the weight of the hub as much as possible on the premise that the strength of the aluminum alloy hub is ensured.

### SUMMARY

The present disclosure relates to the technical field of automobile parts, and specifically relates to a motor vehicle aluminum alloy hub having weight reduction sockets at the back cavity.

Accordingly, the objective of the present disclosure is to provide a hub including weight reduction sockets on the back of spokes.

In one aspect of the present disclosure, a motor vehicle aluminum alloy hub having weight reduction sockets at the back cavity is provided, the hub including a wheel disc and a rim; the rim includes a valve hole; the wheel disc includes a flange, a flange peripheral portion and spokes, and the outer side of the flange is connected to the spokes and the flange peripheral portion; six bolt holes are uniformly distributed in the flange; six decorative holes are uniformly distributed in the flange; one end of each spoke is connected to the outer side of the flange, and the other end is connected to the rim; the wheel disc includes 15 sets of spokes, and one side of the two adjacent sets of spokes facing the flange includes the flange peripheral portion; in which:

The spoke has a lowered slope surface from the flange to the rim; the flange peripheral portion, the adjacent spokes and the edge of the rim jointly surround a first window of a round rectangle; totally 15 windows are formed in sequence; the outer edge of each window includes a front plane surface in a round rectangle shape;

The spoke includes a spoke weight reduction socket on one side of the back cavity, the spoke weight reduction socket is conical, the two ends of the spoke weight reduction socket are 5-10 mm away from the edge of the spoke, and the cross section of each edge of the cone is inverted trapezoidal; the depth of the spoke weight reduction socket is 3-6 mm, and the thickness of the spoke at the bottom of the spoke weight reduction socket is 15-18 mm; on the back of the spoke, the outer side of the spoke weight reduction socket includes a back plane surface, having a width of 5-10 mm.

The spoke includes a flange peripheral portion weight reduction socket communicating with the spoke weight reduction socket on the back of the flange peripheral portion, the flange peripheral portion weight reduction socket is connected to the spoke weight reduction socket, the depth of the flange peripheral portion weight reduction socket is 3-6 mm, and the thickness of the wheel disc at the bottom of the flange peripheral portion weight reduction socket is 25-30 mm; on the back of the flange peripheral portion, the outer side of the flange peripheral portion weight reduction socket includes a back plane surface, having a width of 6-12 mm. The flange includes flange weight reduction sockets between the bolt holes on one side of the back cavity, the surface of the flange weight reduction socket is a curved surface obtained by parabolic rotation, the depth of the flange weight reduction socket is 15-20 mm, and the thickness of the flange at the deepest position is 17-20 mm; and the center of the flange weight reduction socket has a decorative hole reaching the front side and having a diameter of 7-12 mm.

In a preferred aspect of the present disclosure, the angles between the spokes and the plane of the circumference of the wheel disc flange are 110 degrees, and the ends of the spokes are 15 mm lower than the spoke flange.

In a preferred aspect of the present disclosure, the front surface of the flange is a cambered surface, ending at the windows, and the highest position is 3-4 mm away from the surface.

In a preferred aspect of the present disclosure, the flange includes six bolt holes.

In a preferred aspect of the present disclosure, the flange includes six decorative holes.

In a preferred aspect of the present disclosure, each window has a length of 150-170 mm and a width of 20-30 mm.

In a preferred aspect of the present disclosure, the two ends of the spoke weight reduction socket are 6 mm away from the spoke edge; the angle between the outer edge of the spoke weight reduction socket and the surface of the wheel back cavity is 105 degrees, and the angle between the inner edge of the spoke weight reduction socket and the surface of the wheel back cavity is 110 degrees.

In a preferred aspect of the present disclosure, the depth of the weight reduction sockets on the back of the flange is 16 mm, and the thickness of the flange at the deepest position is 19 mm.

Hub back cavity weight reduction sockets in a specific shape are designed for the front side of the specific hub, and the sizes of the weight reduction sockets are selected, thereby reducing the weight of the hub. In addition, the hub after weight reduction still has excellent mechanical properties, meets American wheel SAE J175 and SAE J328-2005 standards, namely meet the performance requirements for 13-degree impact strength, radial fatigue and bending fatigue, and can also meet the requirements of national standards GB/T 5334-2005 and GB/T 15704-1995 for wheel strengths and fatigues.

### BRIEF DESCRIPTION OF DRAWINGS

FIG. 1 is a schematic diagram of a front structure of a hub according to Embodiment 1 of the present disclosure.

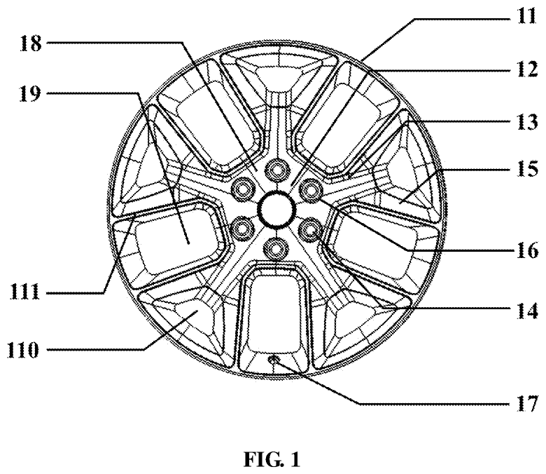

FIG. 2 is a schematic diagram of a back structure of the hub according to Embodiment 1 of the present disclosure.

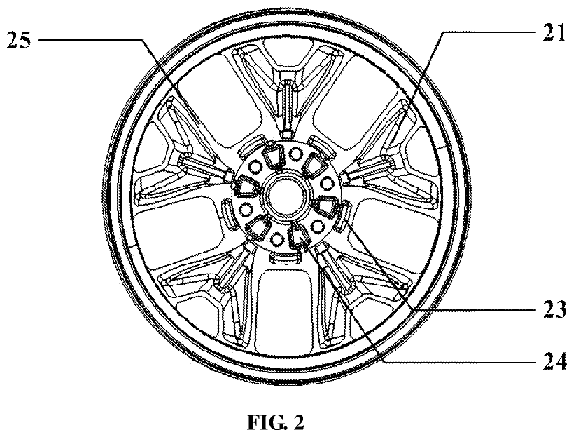

### LIST OF REFERENCE SYMBOLS

11 rim
12 flange
13 spoke
14 decorative hole
15 wheel disc front plane edge
16 bolt hole
17 valve hole
18 flange peripheral portion
19 window
20 spoke weight reduction socket
21 flange weight reduction socket
22 back plane surface

### DETAILED DESCRIPTION

### Embodiment 1

The present embodiment provides a hub including weight reduction sockets on the back of spokes. The hub includes a wheel disc and a rim, the wheel disc includes a flange, a flange peripheral portion and spokes, and the outer side of the flange is connected to the spokes and the flange peripheral portion; one end of each spoke is connected to the outer side of the flange, and the other end is connected to the rim; the wheel disc includes 15 sets of spokes, and one side of the two adjacent sets of spokes facing the flange includes the flange peripheral portion.

The spoke has a lowered slope surface from the flange to the rim; the flange peripheral portion, the adjacent spokes and the edge of the rim jointly surround round rectangles to form 15 windows; and the outer edge of the window includes a front plane surface of a round rectangle shape. The narrow plane of the front surface of the hub has a width of 5 mm, the spoke weight reduction socket is groove-shaped and is lowered in a slope shape, the angle between the slope and the plane is 110°, the depth of the slope is 16 mm, the front surface of the flange is cambered surface, the cambered surface stops at the windows, and the distance between the highest position of the flange and the surface is 3.5 mm.

The spoke includes a spoke weight reduction socket on one side of the back cavity, the spoke weight reduction socket is conical, the two ends of the spoke weight reduction socket are 6 mm away from the edge of the spoke, and the cross section of each edge of the cone is inverted trapezoidal; the depth of the spoke weight reduction socket is 4-5 mm, and the thickness of the spoke at the bottom of the spoke weight reduction socket is 27 mm; the spoke weight reduction socket is in a “cone” shape with two sides 6 mm away from the edge of the spoke, the angle between the outer edge of the weight reduction socket and the surface of the wheel back cavity is 105°, and the angle between the inner edge of the weight reduction socket and the surface of the wheel back cavity is 110°, and the depth of the socket is 4.5 mm.

The spoke includes a flange peripheral portion weight reduction socket communicating with the spoke weight reduction socket on the back of the flange peripheral portion, the flange peripheral portion weight reduction socket is connected to the spoke weight reduction socket, the depth of the flange peripheral portion weight reduction socket is 4 mm, and the thickness of the wheel disc at the bottom of the flange peripheral portion weight reduction socket is 28 mm; on the back of the flange peripheral portion, the outer side of the flange peripheral portion weight reduction socket includes a back plane surface, having a width of 7 mm;

The flange includes flange weight reduction sockets between bolt holes on one side of the back cavity, the surface of the flange weight reduction socket is a curved surface obtained by parabolic rotation, the depth of the flange weight reduction socket is 17 mm, and the thickness of the flange at the deepest position is 19 mm; and the center of the flange weight reduction socket has a decorative hole reaching the front side and having a diameter of 9 mm.

The hub is 15.6 kg in the absence of weight reduction sockets, but 12.1 kg in the presence of the weight reduction sockets, so the weight reduction effect is 22%.

### Embodiment 2

Various properties of the motor vehicle hub of Embodiment 1 were tested. The strengths and fatigues, including 13-degree impact strength, radial fatigue, bending fatigue and the like, of the wheel were tested in the test center. The tests show that the hub meets American wheel SAE J175 and SAE J328-2005 standards, namely meet the performance requirements for 13-degree impact strength, radial fatigue and bending fatigue, and can also meet the requirements of national standards GB/T 5334-2005 and GB/T 15704-1995 for wheel strengths and fatigues.

1. A motor vehicle aluminum alloy hub having weight reduction sockets at a back cavity, wherein the hub comprises a wheel disc and a rim; the rim comprises a valve hole; the wheel disc comprises a flange, a flange peripheral portion and spokes, and an outer side of the flange is connected to the spokes and the flange peripheral portion; six bolt holes are uniformly distributed in the flange; one end of each spoke is connected to the outer side of the flange, and other end is connected to the rim; the wheel disc comprises five sets of spokes, and one side of two adjacent sets of spokes facing the flange comprises the flange peripheral portion; wherein the spoke comprises a spoke main arm on one side close to the flange, two spoke branch arms extend from the spoke main arm, and the spoke branch arms are connected to the rim to form a symmetric Y-shaped spoke; the spoke main arm has a lowered slope surface from the flange to the rim; the flange peripheral portion, adjacent spokes and an edge of the rim jointly surround a first window of a round rectangle; the spoke branch arms of the same spoke and the edge of the rim jointly surround a second window of a round trapezoidal; an inclination angle of the spoke branch arm toward the first window is greater than that toward the second window; an outer edge of the first window comprises a front plane surface in a round rectangle shape; the spoke comprises a spoke weight reduction socket on one side of the back cavity, the spoke weight reduction socket is V-shaped, two ends of the spoke weight reduction socket are 6-12 mm away from an edge of the spoke, and a cross section of each edge of the V shape is inverted trapezoidal; a depth of the spoke weight reduction socket is 8-9 mm, and a thickness of the spoke at a bottom of the spoke weight reduction socket is 10-15 mm; on a back of the spoke, an outer side of the spoke weight reduction socket comprises a back plane surface, having a width of 8-12 mm; a reinforcing rib is formed at a junction of the two arms of the V-shaped spoke weight reduction socket; the spokes comprise five flange peripheral portion weight reduction sockets uniformly distributed around the flange on a back of the flange peripheral portion, the flange peripheral portion weight reduction socket has an upper opening of a round rectangle, a length of 40-50 mm, a width of 15-25 mm and a triangular cross section perpendicular to a length direction; the flange comprises flange weight reduction sockets between the bolt holes on one side of the back cavity, a surface of the flange weight reduction socket is a curved surface obtained by parabolic rotation, the depth of the flange weight reduction socket is 20-22 mm, and the thickness of the flange at a deepest position is 14-18 mm.

2. The motor vehicle aluminum alloy hub having weight reduction sockets at a back cavity according to claim 1, wherein an angle between the spoke main arm and a plane of a circumference of the wheel disc flange is 120 degrees, and an end of the spoke main arm is 10 mm lower than the spoke main arm flange.

3. The motor vehicle aluminum alloy hub having weight reduction sockets at a back cavity according to claim 1, wherein a front surface of the flange is a cambered surface, ending at a Y junction, and a highest position is 3-4 mm away from the surface.

4. The motor vehicle aluminum alloy hub having weight reduction sockets at a back cavity according to claim 1, wherein the flange comprises six bolt holes.

5. The motor vehicle aluminum alloy hub having weight reduction sockets at a back cavity according to claim 1, wherein the first window has a length of 130-150 mm and a width of 70-80 mm.

6. The motor vehicle aluminum alloy hub having weight reduction sockets at a back cavity according to claim 1, wherein two ends of the spoke weight reduction socket are 8 mm away from the spoke edge; an angle between an outer edge of the spoke weight reduction socket and a surface of the wheel back cavity is 112 degrees, and an angle between an inner edge of the spoke weight reduction socket and the surface of the wheel back cavity is 140 degrees.

7. The motor vehicle aluminum alloy hub having weight reduction sockets at a back cavity according to claim 1, wherein the reinforcing rib has a width of 8-12 mm and a height of 4-5 mm.

8. The motor vehicle aluminum alloy hub having weight reduction sockets at a back cavity according to claim 1, wherein the depth of the weight reduction sockets on the back of the flange is 20 mm, and the thickness of the flange at the deepest position is 16.5 mm.
